(19) United States
(12) Patent Application Publication
(10) Pub. No.: US 2004/0197522 A1
(43) Pub. Date: Oct. 7, 2004

(54) Carpet with improved tuft retention

(76) Inventors: Raymond Joseph Reisdorf, Nobressart (BE); Loic Pierre Rolland, Divonne (FR)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/658,082

(22) Filed: Sep. 9, 2003

Related U.S. Application Data
(60) Provisional application No. 60/410,765, filed on Sep. 13, 2002.

(51) Int. Cl. B32B 33/00; D05C 17/02; B32B 31/00

(52) U.S. Cl. 428/97; 428/95; 156/72

(57) ABSTRACT

A tufted carpet is provided having a primary backing with yarn comprised of at least 85% by weight of fibers selected from the group nylon fibers, wool fibers, and blends thereof. A polymer adhesive is applied to the back side of the tufted primary backing, which adhesive consists of at least 85% by weight of one or more ethylene copolymers each comprised of 50 to 95 weight % of ethylene, and 5-50 weight % of at least one comonomer selected from the group of esters and carboxylic acids. The polymer adhesive has a melt index greater than 150 and a tenacity at room temperature of at least 5 Mpa. A secondary backing is adhered to the back side of the primary backing. Preferred comonomers in the ethylene copolymer adhesive include vinyl acetate, butyl acrylate, methyl acrylate, methacrylic acid, and acrylic acid. A process for making the tufted carpet of the invention is also provided.

### BACKGROUND OF THE INVENTION

The present invention relates to carpets and to processes for manufacturing carpets using an extrusion coating process with a thermoplastic adhesive binder. More particularly, the invention relates to tufted carpets that exhibit improved pile fiber retention under conditions of abrasive wear.

Manufacture of tufted carpets normally involves tufting dyed or undyed face yarns into a primary backing. The yarns can be prepared from a variety of materials including natural fibers such as wool or cotton, or synthetic fibers spun from polymers including nylons, polyesters, acrylics and polyolefins. Of these, nylon 66 and nylon 6 are the dominant materials in view of their overall balance of aesthetics, cost and performance in use. The tufting operation is described in detail in U.S. Pat. No. 4,844,765, at column 1, lines 1943, which is incorporated by reference. If the face yarn is undyed, the tufted primary backing is next printed or piece dyed in either a batch or continuous operation. After dyeing, the carpet is washed and dried and usually prepared for application of a secondary backing on the back side of the tufted primary backing. The secondary backing is usually a woven or nonwoven polypropylene or polyester synthetic fabric or a woven jute natural fabric.

The application of the secondary backing as part of the carpet finishing operation has traditionally involved application of a significant quantity of an aqueous latex binder, which typically includes a substantial amount of filler. These latex binders have dominated the industry for many years because of their ability to provide good wetability and good adhesive performance at low cost. In the conventional latex process, a preliminary latex coating (“a precoat”) is first applied to the back of the tufted primary backing in order to fix the fibers in the primary backing. Once this precoat has been dried in an oven, an adhesive latex binder layer and a secondary textile backing are normally applied to the primary backing, after which the latex binder is dried and vulcanized in a dryer. Alternatively, a latex foam may be applied directly to the primary backing in place of the secondary textile backing. A widely used material for the latex adhesive binder is a carboxylated styrene butadiene rubber (XSBR).

There are both process and environmental disadvantages to using aqueous latex binders in the carpet making process. This latex process requires significant drying steps to remove water from the latex and then to set the latex. The drying steps limit production speed and increase the cost of the carpet, especially when thick needlepunched secondary backings are used. This is particularly acute when energy costs rise. Additionally, dryers represent a major capital investment. Carpets made with latex binders also have the disadvantage that they are pervious to water and that they even retain water which makes cleaning such carpets difficult. Additionally, the latex is very difficult to recycle and it generates odors during the process of heating, as may occur during carpet installation.

Accordingly, there has been a long felt need for a process for making durable carpets that use thermoplastic adhesive binders instead of latex binders and there have been attempts to develop carpets made with thermoplastic binders. Bailey, et. al, WO 96/29460A1, pp. 5-8 provides a summary of thermoplastic adhesives that have been considered for finishing tufted carpets. WO 96/29460A1 is directed to a tufted carpet bonded with an adhesive binder that includes a thermoplastic resin and is substantially free of inorganic and latex materials, which carpet exhibits good tuft bind. This publication refers to a test method (ASTM D-1335) for measuring resistance against a whole tuft being pulled from a carpet when snagged, as can occur with loop pile carpets.

Vinod, et. al., WO95/14806, discloses a process for making a tufted nylon or polyester pile carpet where a thermoplastic resin consisting essentially of an ethylene terpolymer having at least 8% by weight ester groups and at least 1% by weight carboxylic acid groups is contacted with a primary carpet backing having nylon or polyester yarn tufts contained therein. Tuft bind strengths of 4-5.5 lbs. (18-25 Newtons), as measured by the ASTM D-1335, are reported.

There is still a need for a commercially acceptable process for producing carpets using thermoplastic adhesive binders which carpets resist fiber loss. Extensive foot traffic, rolling of chair casters and sliding furniture and equipment over cut and loop pile carpets has been found to result in loss of pile fibers from the carpet by abrasive wear that works individual fibers out of the tuft without the entire tuft necessarily being pulled from the carpet. This is a particularly acute problem for short pile height velour carpets which are made primarily using nylon face fibers. There is little entanglement of the individual fibers with each other in the yarn bundle and consequently, unless the binder adhesive contacts essentially all of the individual fibers, binds the fibers, and remains intact under conditions of abrasive wear, then an unacceptably high proportion of the fibers are likely to be abraded out of the carpet leaving unsightly thin spots as well as undesirable contamination of the carpet surface with loose fibers. Where a carpet has a visual design or pattern, the loss of 15 to 20 percent of the carpet yarn fibers results in a substantial deterioration of the carpet's visual appearance.

A test for measuring pile fiber retention that focuses on the abrasive wear commonly experienced in commercial environments is the Lisson Tretrad test, Draft International Standard ISO/DIS 12951-1, which is described in the Test Method section below. The Lisson Tretrad test simulates the abrasive wear that a carpet will experience in a commercial environment where rolling of chair casters over the carpet, heavy foot traffic on the carpet, and sliding furniture and equipment over the carpet are regular events. This Lisson Tretrad test enables one to differentiate the level of effective fiber bind and encapsulation based on cumulative loss of pile fibers, as opposed to the ASTM D-1335 which only measures the force required to completely remove a tuft bundle from the backing. It has been found that there is little correlation between the loss of complete carpet tufts, as measured by ASTM-D-1335, and the loss of carpet fibers under conditions of abrasive wear, as measured by the Lisson Tretrad test ISO 12951-1. For example, Comparative Example 2 below shows a carpet with a satisfactory D-1335 tuft bind of greater than 9 Newtons that still exhibited an unsatisfactory 58% loss of pile fiber under the Lisson Tretrad test.

There is a need for carpets made with polyamide-type face fibers, such as wool or nylon fibers, and a thermoplastic adhesive binder which carpets are suitable for use in high wear commercial environments such as business offices. There is also a need for an efficient process for producing such carpets. The carpet preparation process needs to ensure sufficient contact with the carpet fibers by the binder and good adhesion of substantially all the individual fibers in the tufts so as to hold the carpet fibers in place. Of course, other necessary attributes of the carpet structure, including resistance against delamination of the carpet's secondary textile backing, must be maintained.

### SUMMARY OF THE INVENTION

The present invention is directed to a tufted carpet comprising a primary backing with yarn comprised of at least 85% by weight of fibers selected from the group nylon fibers, wool fibers, and blends thereof, the tufted primary backing having a carpet side and an opposite back side. The carpet has a polymer adhesive applied to the back side of the tufted primary backing, the polymer adhesive contacting the primary backing and fibers of the yarn tufted in the primary backing. The polymer adhesive consists of at least 85% by weight of one or more ethylene copolymers each comprised of 50 to 95 weight % of ethylene, and 5-50 weight % of at least one comonomer selected from the group of esters and carboxylic acids. The polymer adhesive has a melt index greater than 150 according to ASTM D-1238@190° C. with a weight of 2.16 Kg, and a tenacity at room temperature of at least 5 Mpa according to test method DIN 53504-85. The carpet further includes a secondary backing adhered to the back side of the primary backing.

Preferably, the comonomer group of esters and carboxylic acids consists of vinyl acetate, butyl acrylate, methyl acrylate, methacrylic acid, and acrylic acid. More preferably, the polymer adhesive is a terpolymer containing 50-90 weight % ethylene, 5-20 weight % butyl acrylate, and 5-20 weight % methacrylic acid, or the polymer adhesive is a blend of a copolymer containing 50-95 weight % ethylene and 5-50 weight % metharcylic acid and a copolymer containing 50-95 weight % ethylene and 5-50 weight % vinyl acetate.

It is further preferred that the polymer adhesive have a melt index in the range of 200 to 800, and more preferably in the range of 400 to 600, according to ASTM D-1238@190° C. with a weight of 2.16 Kg. The polymer adhesive should have an adhesion to polyamide 6,6 of at least 2 Newtons per 10 mm, according to the Nylon Adhesion Test Method described below, and more preferably of at least 5 Newtons per 10 mm.

The present invention is also directed to a process for preparation of a tufted polyamide-type fiber carpet. A primary backing is tufted with yarn comprised of at least 85% by weight of fibers selected from the group nylon fibers, wool fibers, and blends thereof, the tufted primary backing having a carpet side and an opposite back side. A molten polymer adhesive is provided on the back side of the tufted primary backing, the polymer adhesive consisting of at least 85% by weight of one or more ethylene copolymers each comprised of 50 to 95 weight % of ethylene, and 5-50 weight % of at least one comonomer selected from the group of esters and carboxylic acids. The polymer adhesive has a melt index greater than 150 according to ASTM D-1238@190° C. with a weight of 2.16 Kg, and a tenacity of at least 5 Mpa according to test method DIN 53504-85. The tufted primary backing is then introduced with the molten polymer adhesive into a nip and the molten polymer adhesive is compressed into the tufted primary backing in the nip. Finally, the molten polymer adhesive is cooled to a temperature below its melting point. Preferably, the polymer adhesive has an adhesion to polyamide 6,6 of at least 2 Newtons per 10 mm according to test method DIN 53504-85. It is further preferred that the process include the additional step of adhering a secondary backing to the back of the primary backing so as to form the tufted primary backing, the polymer adhesive and the secondary backing into an integral tufted carpet. The step of adhering the secondary backing to the back of the primary backing may comprises the steps of providing the secondary backing, bringing the side of the secondary backing into contact with the back side of the tufted primary backing to which the molten polymer adhesive has been applied, compressing the tufted primary backing, the molten polymer adhesive layer, and the secondary backing under a moving belt that applies a pressure of at least 1 N/cm² for a period of at least 10 seconds during which time the polymer adhesive remains in a molten state, and removing the moving belt from the tufted primary backing, molten polymer adhesive layer, and secondary backing, and then cooling the molten polymer adhesive to a temperature below the melting point of the molten adhesive so as to form the tufted primary backing the polymer adhesive and the secondary backing into an integral tufted carpet.

### BRIEF DESCRIPTION OF THE DRAWINGS

FIG. 1 is a cross-sectional view of a portion of the carpet of the invention.

FIG. 2 is a schematic view showing a process for producing the carpet of the invention.

FIG. 3 is a schematic view showing a process for producing the carpet of the invention that is similar to the process shown in FIG. 2.

FIG. 4 is a schematic view showing another process for producing the carpet of the invention.

FIG. 5 is a schematic view showing another process for producing the carpet of the invention.

### Definitions

The term “polymer” as used herein, generally includes but is not limited to, homopolymers, copolymers (such as for example, block, graft, random and alternating copolymers), terpolymers, and blends and modifications thereof. Furthermore, unless otherwise specifically limited, the term “polymer” shall include all possible geometrical configurations of the material. These configurations include, but are not limited to isotactic, syndiotactic and random symmetries.

The term “polyolefin” as used herein, is intended to mean any of a series of largely saturated polymeric hydrocarbons composed only of carbon and hydrogen. Typical polyolefins include, but are not limited to, polyethylene, polypropylene, polymethylpentene and various combinations of the monomers ethylene, propylene, and methylpentene.

The term “polypropylene” as used herein is intended to encompass not only homopolymers of propylene, but also copolymers wherein at least 85% of the recurring units are propylene units.

The term “nylon” as used herein is intended to encompass polymer comprising at least 85% of one or more of the known aliphatic polyamide polymers and copolymers commonly referred to as nylons, including polyamide 6, polyamide 66, polyamide 610, polyamide 612, polyamide 11, polyamide 12, polyamide 1212, and polyamide 6/66. Methods for producing these aliphatic polyamides are well known, and include the condensation of equimolar amounts of saturated dicarboxylic acid containing 4 to 12 carbon atoms with a diamine, in which the diamine contains 4 to 14 carbon atoms, as for example the polymerization of hexamethylene diamine and adipic acid [nylon 66] or the polymerization of caprolactum [nylon 6].

The term “nonwoven” as used herein means a structure of individual fibers or threads that are positioned in a random manner to form a planar material without an identifiable pattern, as in a knitted woven fabric.

### Test Methods

Carpet Fiber Retention was measured according to ISO Method DIS 12951-1 (also known as the Lisson Tretrad test) (which has also been designated as European Standard EN-1963), which is incorporated herein by reference. This test method measures the wear durability of a tufted carpet under conditions intended to simulate the abrasive wear common in high traffic commercial environments. The test apparatus consists of a Lisson Tretrad machine which comprises a bed plate on which a carpet sample is supported under tension, a Tretrad assembly that applies abrasive force to the carpet sample, and a vacuum cleaning system that collects carpet fibers that come loose during testing. The Tretrad assembly includes a wheel with four legs spaced at 90° angles from each other. A disk shaped foot covered with a rubber sole is attached to the end of each leg. During testing, the feet press down on the carpet sample with a vertical force of 150 Newtons and are moved along the carpet by a lever arm as the wheel is continuously rolled back and forth over the carpet. The linear speed of the Tretrad arm is 0.28 m/sec. and the peripheral speed of the feet is 20% greater than the linear speed, leading to slippage of the feet on the test specimen. Suction nozzles follow the feet to collect any fibers abraded out of the carpet. The abraded fibers are weighed and a fiber retention index I_{TR} is calculated by the following formula:

I_{TR}=0.19 {M_{AP} [100−M_{RV}]/100}^{1/2}, where

M_{AP} is the mass of pile per unit area above the primary backing in g/m²

M_{RV} is the percent fiber weight lost, which is determined by the formula:

M_{RV}=(M_{V}/M_{AP})100, where

M_{V}=the weight of the fibers collected from the carpet (in grams) divided by the tested area of carpet (in square meters)

Melt index was determined according to ASTM D-1238@190° C. with a weight of 2.16 Kg and is reported without units.

Tensile strength was determined by DIN 53504-85 or S2/ISO 37 T2, which is hereby incorporated by reference. In the test a 0.3 cm by 7.5 cm dumbbell sample (as described in 53504-85 or S2/ISO 37 T2) was clamped at opposite ends of the sample. The clamps were attached 5 cm from each other on the sample. The sample was pulled steadily at a speed of 200 mm/min until the sample broke. The stress at break was recorded in MPa as the breaking tensile strength. The elongation at break was recorded as a percent.

Adhesion was measured by the following Nylon Adhesion Test Method. A 2 mm thick polyamide 6,6 plate was prepared using a press at a temperature of 270° C. Polyamide 6,6, in granular form was introduced into the press and was preheated under a pressure of 5 Bars for 5 minutes. The pressure was increased to 100 Bars for a period of 2 minutes. The plate was cooled for about 8 minutes (while the pressure of 100 Bars was maintained) and it was then removed from the press. A 2 mm thick plate of the adhesive polymer was prepared by the same procedure, but at a temperature of 150° C. Adhesive polymer in granular form was introduced into the press and was preheated under a pressure of 5 Bars for 5 minutes. The pressure was then increased to 100 Bars for a period of 2 minutes. The plate was cooled for about 8 minutes (while the pressure of 100 Bars was maintained) and it was then removed from the press. The polyamide 6,6 plate and the adhesive polymer plate were then pressed between the jaws of a press maintained at 150° C. for the jaw in contact with PA66 and room temperature for the jaw in contact with the adhesive polymer and under a pressure of 20 Bars for 1 minute to adhere the two plates to each other. The adhered plates were left in the press and cooled to approximately room temperature before being removed from the press. One cm by 15 cm strips of this structure were then prepared and the adhesive polymer was delaminated manually from the PA66 over a length of 3 cm. The adhesive section was then removed from the polyamide 6,6 section by clamping the manually delaminated ends of the sample in the jaws of a tensile testing equipment. The clamps were attached 2 cm from each other. Delamination was done steadily at a speed of 50 mm/min. The force required to delaminate the adhesive from the polyamide 6,6 was measured and reported in units of N/cm.

Visual Aspect was rated, as prescribed in the norm DIN EN 1963-part A, using the following scale:

1. Failure. Extreme structure change in wear areas, such as primary backing being visible due to missing yarn tufts, more than three cut pile or loops missing in test area (for loop carpets), hairy loose filaments with length ≧15 mm observed.

2. Satisfactory. Suitable for residential purposes. Moderate structure change in wear area, such as some loss of yarn twist (Saxony) and or loss of bulkiness, hairy loose filaments with length of 5 to 15 mm, some bristle in carpet loops (for cut and loop carpets).

3. Good. Suitable for normal traffic commercial purposes. Small structure change in wear area, such as minor loss of yarn twist, hairy loose filaments with length ≧5 mm, almost no damage of tufted pile surfaces. Surface integrity fully maintained.

4. Very Good. Suitable for high traffic commercial purposes. Very little structure change in wear area, surface integrity fully maintained.

### DETAILED DESCRIPTION

The carpet of the invention has a polyamide-type face yarn, such as nylon, wool, or blends thereof, and it is prepared by a conventional tufting process. The polyamide-type yarn is tufted into a sheet of a primary backing material. A special thermoplastic adhesive is applied to the portion of the tufts extending through the backside of the primary backing so as to lock the yarn fibers in place. As used herein, “fibers” refers to both continuous filament fibers and staple fibers. As shown in FIG. 1, a primary backing 10 is tufted with a face yarn 12. An adhesive 14 is applied to the backside of the tufted primary backing and a secondary backing 16 is preferably adhered to the adhesive 14. Preferably, the tufted carpet 20 is comprised of polyamide-type fiber yarn such as nylon or wool, tufted on a polyolefin spunbonded primary backing. More preferably, tufted carpet 20 has a cut pile, loop pile, or a combination of the two, and is comprised of nylon face yarn. A preferred carpet is made with ANTRON®nylon 66 yarn sold by E.I. du Pont de Nemours and Company (“DuPont”), and is tufted on a polypropylene spunbonded nonwoven primary backing, such as TYPAR® nonwoven sheet sold by DuPont.

According to the invention, a specially formulated polymer adhesive is applied to the back of a tufted primary backing in a manner that penetrates the yarn tufts so as to contact most or all of the fibers in the tufts. The adhesive is formulated so as to adhere to the polyamide-type fibers in the tufts and lock essentially all of the fibers in the tufts. The adhesive may also be formulated to adhere to the secondary backing material that may be applied to the back side of the carpet over the adhesive.

The polymer adhesive used in the carpet of the invention is specially formulated to perform a number of different functions. First, the adhesive must be made so that it can impregnate the fiber networks of the tufts and contact the overwhelming majority of the fibers in the tufts. The adhesive, in its molten state, must have a low enough viscosity such that the adhesive is able to fully penetrate into the fiber network of the portion of the carpet tufts extending through the backside to the primary backing. Preferably, the adhesive is compatible with the fibers of the carpet such that the adhesive readily wets the fibers of the polyamide-type carpet tufts. Second, the adhesive must be formulated such that it adheres to the polyamide-type fibers in the carpet tufts. This adhesion is needed to keep the carpet fibers locked in the carpet by the adhesive binder when the carpet is subjected to abrasive wear. Preferably, the adhesive chemically bonds to the polyamide-type fibers of the carpet tufts. Third, the adhesive, in its solidified state, must have a sufficient tensile strength so that the adhesive will not break or release when the fibers are pulled from the carpet during abrasive wear.

Adhesion to a sufficient percentage of the fibers in the tufts in the carpet so as to hold the fibers in place is achieved through careful formulation of the adhesive polymer and through control of application process conditions. The polymer adhesive needs to have an extrusion viscosity and an affinity for the carpet fibers that enable it to contact and wet a substantial majority of the fibers in the tufts. The viscosity of the molten adhesive is controlled through the polymerization process used to produce the adhesive and by adjusting the temperature at which the adhesive is extruded during the carpet making process. A less viscous polymer adhesive, having a higher melt index, can be obtained by slowing the polymerization process, by increasing the amount of polymer chain initiators used during the polymerization, and/or by reducing the polymerization time so as to decrease the length of the polymer chains and hence decrease the average molecular weight of the polymer adhesive. However, reducing the average molecular weight of the polymer adhesive can adversely reduce the tenacity of the adhesive. It has been found that by reducing the amount of comonomer used during the polymerization, it is possible to obtain an adhesive polymer with both the desired high tenacity and the desired relatively low viscosity. It has also been found that the wetting property of the adhesive for the polyamide-type fibers of the carpet face yarn can be improved by including a polar component in the adhesive polymer.

The thermoplastic polymer adhesive used to bind the fibers of the tufts of the carpet of the invention is a resin from the group of ethylene copolymers and terpolymers comprising 50-95 weight % ethylene and 5-50 weight % of one or more comonomers which are either esters or carboxylic acids. Examples of suitable ester comonomers are vinyl acetate, butyl acrylate or methyl acrylate. Examples of desired carboxylic acids are methacrylic acid and acrylic acid. The polymer adhesive used in the process of the invention may also comprise blends of such ethylene copolymers and terpolymers. For example, an adhesive that is a blend of a first copolymer of ethylene and vinyl acetate and a second copolymer of ethylene and methacrylic acid has been formulated that functions well as the thermoplastic polymer adhesive for the carpet of the invention. The ethylene/vinyl acetate component is believed to have a degree of polarity that improves wetting of the adhesive for polyamide-type fibers, and the ethylene/methacrylic acid component of the adhesive is believed to provide chemical bonding between the adhesive and the polyamide-type fibers. Another preferred thermoplastic adhesive is a terpolymer containing 50-98 weight % ethylene, 1-25 weight % butyl acrylate, and 1-25 weight % methacrylic acid. More preferably, this terpolymer is from the family of terpolymers containing 60-90 weight % ethylene, 5-20% butyl acrylate and 5-20% methacrylic acid. In this terpolymer, the butyl acrylate is believed to contribute the polarity needed for good wetting of the polyamide-type fibers and the methacrylic acid component is believed to chemically bond to the polyamide type fibers.

For the ethylene copolymer or terpolymer polymer adhesive of the invention, the adhesive needs to have a melt index greater than 150, according to ASTM D-1238@190° C. with a weight of 2.16 Kg, to be usable in most commercial scale carpet manufacturing processes. More preferably, the polymer adhesive has a melt index in the range of 200 to 800, and most preferably in the range of 400 to 600 according to ASTM D-1238@190° C. with a weight of 2.16 Kg. However, when a low viscosity polymer adhesive with a melt index greater than 150 is used, it is difficult to apply a uniform layer of the adhesive to the backside of the primary backing because such low viscosity polymers tend to run rather than forming uniform films. It has been found that such low viscosity polymer adhesive can still be uniformly applied to the backside of the primary backing if the distance that the molten adhesive travels from the extrusion die before contacting the primary backing is kept at less than 5 cm, and more preferably at less than 1 cm. The adhesive application temperature will vary with the adhesive formulation and the composition of the carpet face yarn, but with the preferred ethylene copolymer and terpolymer adhesives described above, the extrusion temperature is preferably in the range of 150 to 325° C. The adhesive application rate will vary with the adhesive, the application conditions and the composition of the tufted primary backing. For most carpet systems and adhesives, application rates of at least 150 g/m² and more optimally from 250 g/m² to 600 g/m² will be effective. In the processes described below, the adhesive polymer is pressed into the portion of the yarn tufts extending through the backside of the primary backing so as to drive the molten polymer adhesive into contact with the maximum number of fibers in the carpet tufts before the adhesive cools. Preferably, the adhesive will penetrate into at least 60% of the void spaces within the fiber network of the tufts that are on the backside of the primary backing. More preferably, the adhesive will penetrate at least 80% of the void spaces within the fiber network of the tufts that are on the backside of the primary backing.

The ethylene copolymer or terpolymer polymer adhesives of the invention are formulated to adhere well to the polyamide-type fibers of tufts of the carpet of the invention. The polymer adhesive preferably has an adhesion to polyamide 6,6 of at least 2 Newtons per 10 mm, and more preferably of at least 5 Newtons per 10 mm, measured according to the adhesion test method described above. The ethylene copolymer or terpolymer polymer adhesive used in the carpet of the invention is further formulated so as to have a sufficient tenacity in its solidified state so as to not break and release fibers when the fibers of the carpet tufts are pulled during abrasive wear. The adhesive should have a tenacity of at least 5 Mpa, measured according to test method ASTM D 412. Unfortunately, formulating an adhesive for increased adhesion and tenacity typically results in a more viscous adhesive with a relative low melt index of less than 100 that will not be preferred for use in the commercial-scale carpet production processes described below. The ethylene copolymer and terpolymer adhesives of the inventions have been specially formulated to provide an ideal combination of a relatively low viscosity polymer adhesive that also adheres well to polyamide-type face fibers and also has a high enough tenacity to keep the fibers locked in place even when the carpet is subjected to heavy wear conditions.

Preferably, the secondary backing 16 of the carpet shown in FIG. 1 is a needlefelt fabric comprised of fibers of polypropylene, polyethylene terephthalate or a combination of the two. One preferred needlefelt is a 5 mm thick fleece with a basis weight of about 550 g/m² comprised of 80% fine polypropylene fibers (˜2 dtex) and 20% polyethylene terephthalate fibers having a melt temperature that is lower than the melt temperature of the polypropylene fibers. Another preferred secondary backing is a sheet of rubber or thermoplastic polymer, such as a foam rubber. A polymer sheet that can be used as the secondary backing is KELDAX® sheet material, sold by DuPont, which contributes added weight, noise damping, flame retardancy, and antislip properties to a finished carpet, while also giving the carpet a greater affinity for the glues commonly used for gluedown carpet installations. When the secondary backing is a thermoplastic sheet or foam, the secondary backing can be extruded with the polymer adhesive.

One process for producing the carpet of the invention is shown in FIG. 2. A tufted primary backing 11 comprised of a polyamide-type face fiber yarn on a primary backing sheet material is unwound from roll 22 and fed to a nip 24 by means of guidance rolls 25 and a bending roll 27. The nip 24 is formed between a nip roll 26 and a chill roll 28. A secondary backing material 30, such as a woven, nonwoven or needlefelt fabric, or a thermoplastic sheet, is fed from roll 32 over guidance roll 33 into the nip 24. The nip roll 26 is preferably a roll with an elastic surface, and may be a 6 inch (15.2 cm) diameter roll with a rubberized surfaced roll having an 80 shore A hardness that is covered with a 1.5 mm thick Teflon® sleeve. Chill roll 28 is preferably a 300 to 1000 mm diameter cooled roll with a metal surface.

The specially formulated thermoplastic adhesive polymer is melted in an extruder 34, such as a screw extruder, and fed through a heated die 36 to form a uniform layer of molten adhesive 38. In the process shown in FIG. 2, the molten adhesive layer 38 is applied to the backside of the primary backing of the tufted carpet 11 just before the primary backing and the secondary backing come together to pass into the nip 24. The distance from the exit of the die 36 to the point where the adhesive melt contacts the backside of the primary backing is preferably less than 5 cm, and is more preferably less than 1 cm, such that a uniform film of the polymer adhesive can be applied over the full width of the primary backing. Alternatively, the molten adhesive can be applied to the back of the primary backing or the back of the secondary backing some distance before the point where the primary backing joins the secondary backing, so long as the adhesive polymer is still in a molten state when the primary and secondary backings enter the nip. If the period between the application of the molten adhesive polymer and the nip is great enough that the polymer might begin to solidify before reaching the nip, heaters such as infrared heaters can be utilized to keep the adhesive in a molten state.

The nip pressure must be sufficient to drive the molten polymer adhesive into the fiber network of the portion of the carpet tufts extending through the backside of the primary backing. The tufted primary backing and the molten adhesive are preferably pressed between the nip roll 26 and chill roll 28 with a linear pressure that is in the range of 100 to 500 N/cm. When a secondary backing is adhered to the back of the primary backing in the same step, the nip pressure is not substantially different. The chill roll 28 sets the adhesive before the carpet is removed from the chill roll by a stripper roller 37 which preferably has a rubberized surface and a Shore A hardness of 60 to 100. The finished carpet 20 passes over guidance rollers 38 and 39 before being wound up on roll 40. Alternatively, where the carpet is to be produced in flat tile form, the roll 40 will be replaced by a sheet cutter and collector system. Those skilled in the art will recognize that the process described can be augmented with optional equipment such as preheating ovens or corona treatments to facilitate adhesion, and with applicators for the addition of additives to the adhesive polymer.

The setting of the polymer adhesive is controlled by the selection of the size and temperature of the chill roll, the wrap angle on the chill roll, and the line speed. Preferably, the chill roll is maintained at a temperature in the range of 4 to 40° C., and more preferably in the range of 8 to 25° C. By the time the finished carpet comes off the chill roll, the polymer adhesive should have cooled sufficiently such that the fibers in the carpet tufts are firmly locked into the tufts. In addition, where a secondary backing is introduced into the nip with the primary backing and the molten polymer, it is important that by the time the finished carpet comes off the chill roll that the polymer adhesive be cool enough to firmly adhere the secondary backing to the primary backing.

In an another process for producing the tufted carpet of the invention that is not shown, the specially formulated adhesive polymer can be applied to the backside of the primary backing of the tufted carpet and then passed through a nip as shown in FIG. 2, but without the introduction of a secondary backing material. The pressure of the nip forces the molten adhesive into the fiber networks of the carpet tufts where the adhesive contacts the fibers of the tufts before the adhesive is cooled by a chill roll. A secondary backing may be subsequently applied to the back of the primary backing in a separate step. The secondary backing may be adhered to the back of the primary backing using the same thermoplastic adhesive as was used to lock the fibers in the carpet tufts or with another thermoplastic adhesive.

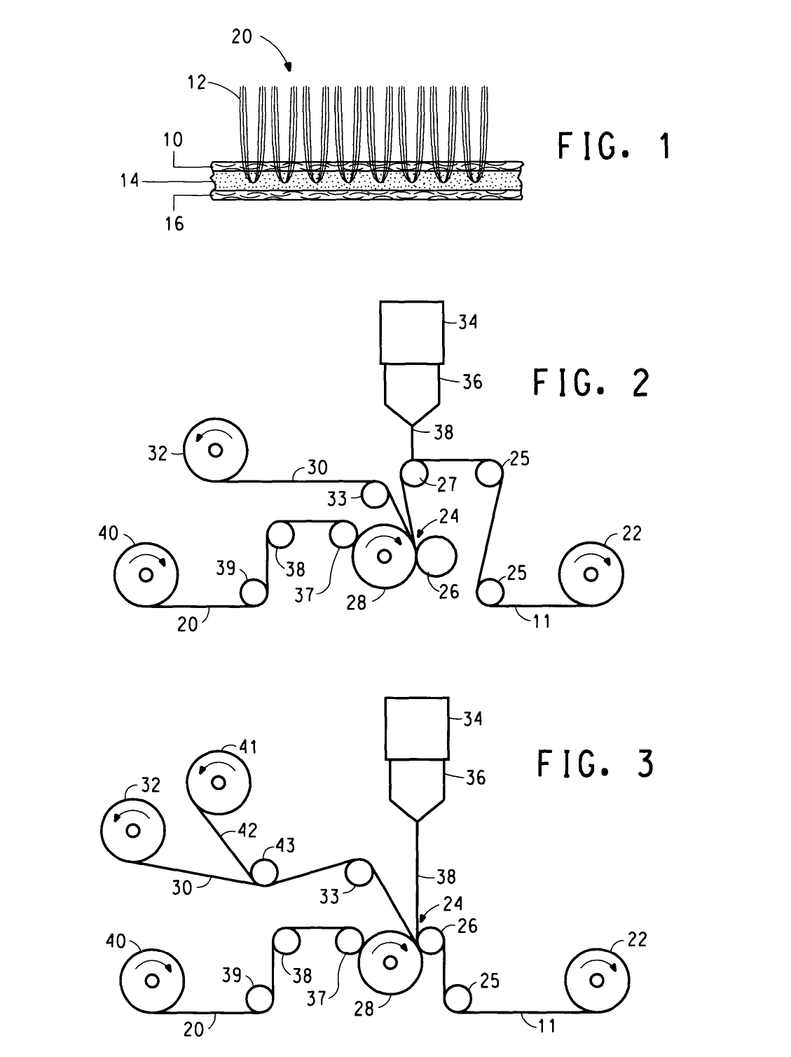

According to another process for making the carpet of the invention that is shown in FIG. 3, a reinforcing grid 42 can be fed into nip 24 from a roll 41 over guide roll 43 so as to provide additional dimensional stability to the carpet. The reinforcing grid 42 may be a reinforcing scrim material such as a fiberglass grid, a polyester grid, or any other material that provides good dimensional stability at a temperature up to 90° C. Preferably, the reinforcing grid 42 is a glass fiber grid with a basis weight of about 60 g/m² made with a 340 dTex glass fiber warp yarn and a 680 dTex glass fiber weft yarn. When a reinforcing grid 42 is used, the tufted primary backing, the secondary backing with the reinforcing grid, and the molten polymer adhesive are pressed between the nip roll 26 and chill roll 28 as described above and the adhesive is set before the finished carpet is removed from the chill roll 28 and wound up on roll 40.

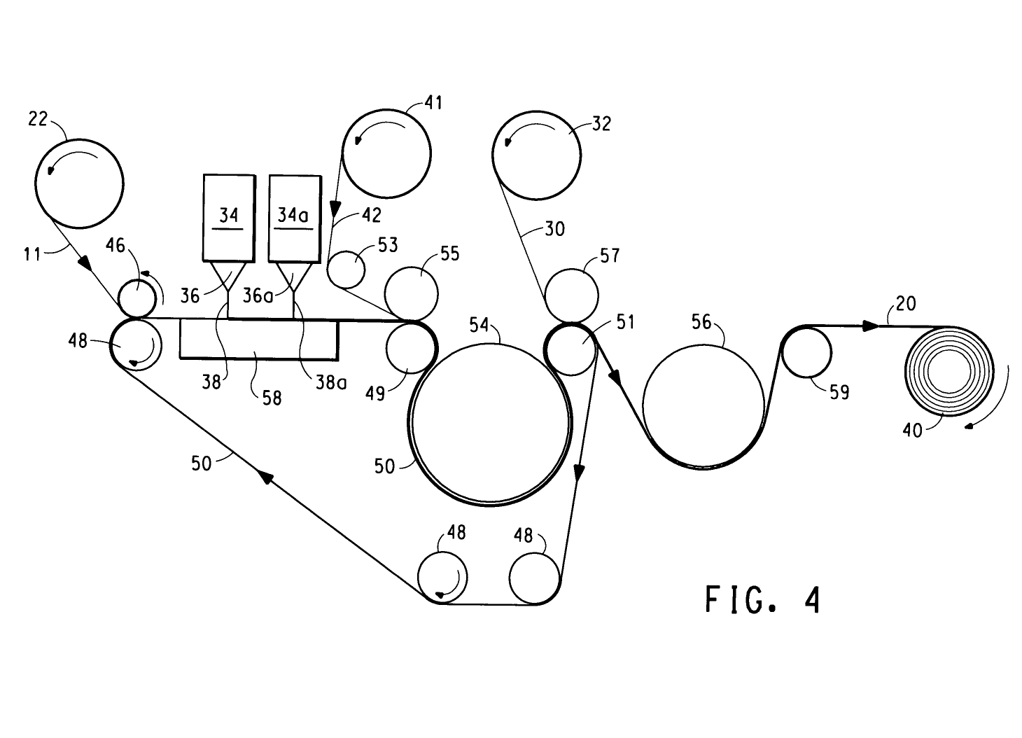

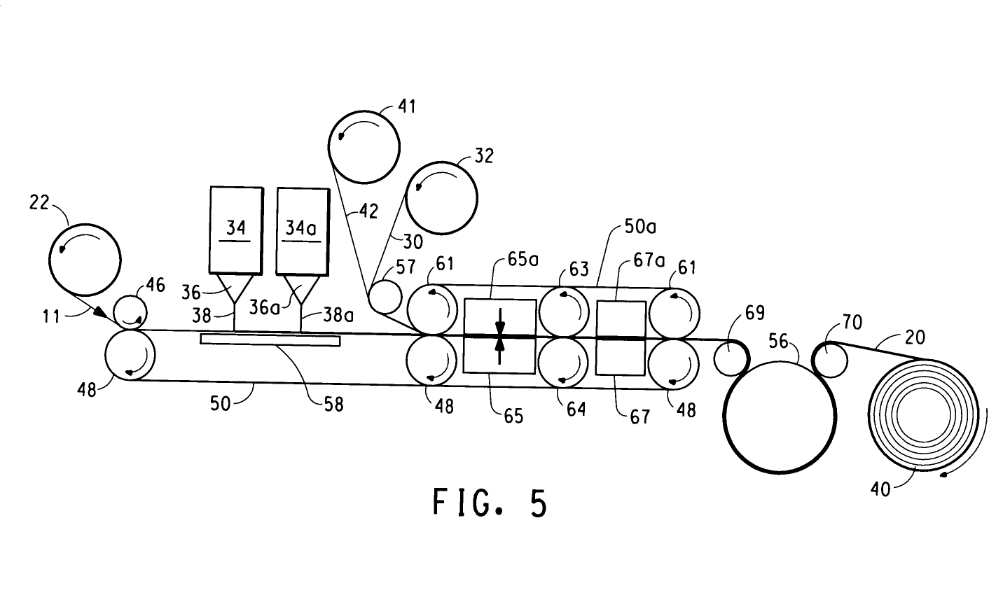

A preferred process for producing the carpet of the invention uses a laminator in conjunction with a pressure belt that helps press the molten polymer adhesive into contact with the fibers of the portions of the face yarn passing through the backside of the primary carpet backing. A laminator with a large belted heated drum is shown in FIG. 4, and a laminator with an extended belted flat bed is shown in FIG. 5.

In the laminator with a belted drum shown in FIG. 4, a tufted primary backing is first coated with one or more polymer adhesives and then pressed against a large heated drum so as to drive the adhesive into the yarn on the backside of the primary backing before a secondary backing is applied over the adhesive and the carpet is cooled to solidify the polymer adhesive. A tufted primary backing 11 comprised of a polyamide-type face fiber yarn on a primary backing is unwound from roll 22 and passed between a guide roller 46 and a belt roller 48. The carpet face yarn is directed downward such that the carpet face yarn comes into contact with the belt 50 that is moving on the belt roller 48. The belt is preferably made of a high strength fabric coated with a non-sticking polymer such as Teflon® PTFE. The belt 50 is maintained under a tension sufficient to press the carpet against the drum 54 with a pressure of at least 1 N/cm² and more preferably of from 2 to 10 N/cm². The belt moves at a speed of 1 to 100 meters per minute, and more preferably of 10 to 30 meters per minute. The specially formulated thermoplastic adhesive polymer described above is melted in an extruder 34, such as a screw extruder, and fed through a heated die 36 to form a uniform layer of molten adhesive 38. The molten adhesive layer 38 is applied on the backside of the primary backing 11 at an application rate sufficient to cover the backside of the tufted primary backing and penetrate into the void spaces between the fibers of the portions to the face yarn tufts passing through the back side of the primary backing of the carpet. The distance from the exit of the die 36 to the point where the adhesive melt contacts the backside of the primary backing is preferably less than 5 cm, and is more preferably less than 1 cm, such that a uniform film of the polymer adhesive can be applied over the full width of the primary backing. A second extruder 34a with a second heated die 36a may be used to apply a layer of a more viscous and less costly adhesive 38a over the adhesive layer 38. The second adhesive layer does not need to penetrate the yarn tufts, but instead, it serves to fill in the valleys on the backside of the tufted primary backing which helps the belt to press the less viscous adhesive 38 into the yarn tufts. During the extrusion step, the table 58 supports the belt 50 and the tufted primary backing so that the distance between the primary carpet backing and the extruder die openings is kept constant.

The belt 50 and the adhesive coated primary backing 11 are directed by a transfer roller 49, which may be heated, onto a large diameter heated drum 54. Drum 54 preferably has a diameter of from 1 to 3 meters, has a metal surface coated with an anti-stick polymer, and is heated by steam or hot oil such that the surface of the drum 54 is maintained at a temperature of 130 to 180° C. The tension on the belt 50 exerts a radial force against the face yarn side of the tufted primary backing 11, and the primary backing 11 is in turn pressed against the heated drum 54 such that molten polymer adhesive coated on the backside of the of the primary carpet backing is gradually pressed into nearly all of the void spaces within the yarn tufts extending through the backside of the primary carpet backing. If it is desired to incorporate a reinforcing grid into the carpet for added dimensional stability, the reinforcing grid material may be applied over the molten adhesive layer before or after the laminated primary backing is contacted with the heated drum. In FIG. 4, a reinforcing grid 42 is shown being applied over the molten adhesive by the guide rollers 53 and 55 just before the primary backing is pressed against the heated drum 54. The reinforcing grid 42 may be any of the reinforcing scrim materials discussed above.

A stripper roll 51 removes the tufted primary backing 11 and molten polymer adhesive coating from the heated drum 54. A secondary backing material 30, such as a woven, nonwoven or needlefelt fabric, or a thermoplastic sheet, is fed from roll 32 and around a roller 57 that presses the secondary backing against the adhesive-coated back side of the tufted primary backing 11. The carpet, which is now comprised of at least the tufted primary backing 11, the adhesive polymer 38 and the secondary backing 30, are removed from the rotating belt 50 and transferred to a chill roll 56. The chill roll 56 sets the adhesive polymer before the carpet is removed from the chill roll by a stripper roller 59. The setting of the polymer adhesive is controlled by the selection of the size and temperature of the chill roll, the wrap angle on the chill roll, and the line speed. Preferably, the chill roll is maintained at a temperature in the range of 4 to 40° C., and more preferably in the range of 8 to 25° C. Cooling can be increased through the use of multiple chill rolls. By the time the finished carpet comes off the chill roll, the polymer adhesive should have cooled sufficiently such that the fibers in the carpet tufts are firmly locked (into the tufts). The finished carpet 20 is finally wound up on roll 40. Those skilled in the art will recognize that the process described can be augmented with optional equipment such as belt heaters, additional cooling rolls, and applicators for the addition of additives to the adhesive polymer.

In an alternative embodiment of the invention, the process shown in FIG. 4 may be modified such that the secondary backing material 30 is applied over the molten adhesive layer 38 before the tufted primary backing 11 passes between the rollers 49 and 55 and around the drum 54 of FIG. 4. With such an arrangement, the secondary backing material is interposed between the molten polymer and the surface of the drum 54 such that the possible sticking of the molten polymer to the drum is avoided.

Another laminator for producing the carpet of the invention has a belted flat bed, and is shown in FIG. 5. With this flat bed laminator, the back side of a tufted primary backing is first coated with one or more polymer adhesives and a secondary backing is subsequently fed through the flat bed where the carpet is pressed between heated moving belts before being cooled to solidify the polymer adhesive. A tufted primary backing 11 comprised of a polyamide-type face fiber yarn on a primary backing is unwound from roll 22 and passed between a guide roller 46 and a belt roller 48. The carpet face yarn is directed downward such that the carpet face yarn comes into contact with the belt 50 moving around belt roller 48. The belt 50 is preferably made of a high-strength fabric coated with a non-sticking polymer such as Teflon® PTFE. The belt 50 is maintained under light tension and it preferably moves at a speed of 10 to 30 meters per minute. The specially formulated thermoplastic adhesive polymer described above is melted in an extruder 34, such as a screw extruder, and fed through a heated die 36 to form a uniform layer of molten adhesive 38. The molten adhesive layer 38 is applied over the back side of the primary backing of the tufted carpet 11 at an application rate sufficient to cover the backside of the tufted primary backing and to penetrate into the void spaces between the fibers of the portions to the face yarn tufts passing through the back side of the primary backing of the carpet. The distance from the exit of the die 36 to the point where the adhesive melt contacts the backside of the primary backing is preferably less than 5 cm, and is more preferably less than 1 cm, such that a uniform film of the polymer adhesive can be applied over the full width of the primary backing. A second extruder 34a with a second heated die 36a may be used to apply a layer of a more viscous and less costly adhesive 38a over the adhesive layer 38. This second adhesive layer does not need to penetrate the yarn tufts, but instead, it serves to fill in valleys on the backside of the tufted primary backing which helps the belts to press the less viscous special polymer adhesive into the yarn tufts. The table 58 supports the belt 50 and the back of the tufted primary backing so that the distance between the primary carpet backing and the extruder dies is kept constant.

A secondary backing material 30, such as a woven, nonwoven or needlefelt fabric, or a thermoplastic sheet, is fed from roll 32 and around a guide roller 57 to a belt roller 61 that presses the secondary backing against the adhesive-coated back side of the tufted primary backing 11. Optionally, a reinforcing grid may be incorporated into the carpet between the secondary backing and the molten adhesive layer to improve the dimensional stability of the carpet. A reinforcing grid 42 may be fed from the roll 41 and brought into contact with the secondary backing by the guide roller 57 just before a belt roller 61 presses the secondary backing and reinforcing grid against the adhesive-coated back side of the tufted primary backing 11. The reinforcing grid 42 may be any of the reinforcing scrim materials discussed above. The roll 61 and the roll 48 are preferably biased toward each other with a constant pressure of about 10 N/cm² so as to force the tufted primary backing coated with molten polymer adhesive and the secondary backing into engagement with each other.

The carpet is next passed through a flat bed laminator having a heated pressure section, a nip, and a cooling section. The flat bed laminator has belts 50 and 50a that are set with a gap between them that is approximately 40 to 80 percent of the total thickness of tufted primary backing and the secondary backing. The gap between the belts 50 and 50a is maintained by the spring-loaded heat and pressure application modules 65 and 65a which apply a surface pressure to the carpet of from 0.5 to 10 N/cm². The belts 50 and 50a are preferably made of high strength fabric coated with a non-sticking polymer such as Teflon® polytetrafluoroethylene. The belts 50 and 50a are heated to a temperature that allows the molten polymer to remain in molten form, and is preferably in the range of 100 to 175° C., and more preferably between 120 and 150° C. As the carpet is squeezed in the gap between the belts 50 and 50a, the molten polymer is gradually forced into the void spaces within the portion of the yarn tufts passing through the backside of the primary carpet backing. Preferably the belts 50 and 50a are heated by resistance heaters, but they may alternatively be heated by other means such as hot air or steam. The belts move at a linear speed timed to allow the adhesive polymer to be pressed into most of the void spaces between the fibers in the portion of the yarn tufts extending through the backside of the primary backing before entering the nip formed between the rolls 63 and 64. Preferably the belts 50 and 50a each move at substantially the same speed. The carpet is preferably squeezed between the belts 50 and 50a for a period of from 5 to 15 seconds.

The space between the rolls 63 and 64 is preferably maintained at about 80% of the gap between the belts 50 and 50a. Rolls 63 and 64 preferably have metal or hard rubber surfaces. The nip formed between the rolls 63 and 64 serves to drive the molten adhesive into substantially all of the void spaces between the fibers in the portion of the yarn tufts extending through the backside of the primary backing. Cooling units 67 and 67a cool the belts and carpet after they exit the nip formed between the rolls 63 and 64. The cooling units 67 and 67a may be spring-loaded water-chilled modules having a smooth non-sticking surface that contacts the moving belt or they may alternatively comprise air fans that cool the belts and the carpet. The cooling units 67 and 67a cool the carpet to a temperature that allows the adhesive polymers to begin to solidify before exiting the flat bed laminator. The final belt rolls 48 and 61 remove the belt from the carpet before the carpet is directed by a guide roll 69 onto the chill roll 56. The chill roll 56 sets the adhesive before the carpet is removed from the chill roll by another guide roll 70. The setting of the polymer adhesive is controlled by the selection of the size and temperature of the chill roll, the wrap angle on the chill roll, and the line speed. Preferably, the chill roll is maintained at a temperature in the range of 4 to 40° C., and more preferably in the range of 8 to 25° C. By the time the finished carpet comes off the chill roll, the polymer adhesive should have cooled sufficiently such that the fibers in the carpet tufts are firmly locked. The finished carpet 20 is subsequently wound up on roll 40. Those skilled in the art will recognize that the process described can be augmented with optional equipment such as additional belt heaters, nip rolls, cooling rolls, corona treatments, and applicators for the addition of additives to the adhesive polymer.

In an alternative process for making the carpet of the invention, the polymer adhesive described above can be spread in fine powder form directly on the backside of the tufted primary backing by means of one or several powdering units used in place of the die extruders. The powdered adhesive is then melted by radiant heaters such that the polymer adhesive is spread in molten form over the backside of the tufted primary backing before the molten polymer is pressed into the carpet yarn tufts by the processes shown in FIGS. 2, 3, 4 and 5.

In another alternative process for making the carpet of the invention, the polymer adhesive described above can be spread in fine powder form directly on one side of the secondary backing material by means of one or several powdering units used in place of the die extruders. The powdered adhesive is then melted by radiant heaters such that the polymer adhesive is spread in molten form over the one side of the secondary backing which side is then brought into contact with the backside of the tufted primary backing. The molten polymer is then pressed into the carpet yarn tufts by any of the processes shown in FIGS. 2, 3, 4 and 5.

In yet another alternative process, the specially formulated polymer adhesive can be spread, in fine powder form, on a moving belt with a non-stick surface and subsequently melted with radiant heaters. The melted polymer is then transferred from the belt, at the exit of the radiant heaters, by means of a nip roll onto the backside of the primary tufted backing. This alternative process can also be used to replace the die extruders of the processes shown in FIGS. 2, 3, 4 and 5.

The processes described above for producing the carpet of the invention consume considerably less space and energy than is the case with a conventional latex coating process. The carpets of the invention are latex-free and odorless. They are generally waterproof and they do not retain moisture which provides both hygienic and cleaning advantages, making such carpets ideal for hospital and nursing home use. In addition, the carpets of the invention can be recycled and they are easier to handle than conventional latex-based carpets due to their lower mass per unit area. Depending on the secondary backing utilized, the process of the invention can be used in the production of broadloom carpets, carpet tiles or automotive carpets. Carpets made by the process of the invention retain a very high proportion of their fibers under abrasive wear conditions. These carpets exhibit a Tretrad fiber retention index (ITR) greater than the 1.7 (as is desirable for residential carpets), and even greater than the index of 3.0 (as is desirable for commercial carpets).

### EXAMPLES

In the following examples, tufted carpets were prepared. The process conditions and wear data for the examples are summarized in Table 1.

### Comparative Examples 1 and 2

Comparative Examples 1 and 2 were prepared using a low viscosity ethylene terpolymer adhesive and under unacceptable process conditions. In Comparative Examples 1 and 2, the carpet was a 1/10 inch (2.54 mm) gauge cut pile nylon 66 velour carpet with a face fiber weight of 580 g/m². The primary backing was a 108 g/m² polypropylene spunbonded nonwoven and the nylon 66 face yarn was a 1360 dTex bulk continuous filament (“BCF”) yarn. The adhesive resin used was a terpolymer of 80 weight % ethylene, 10 weight % butyl acrylate and 10 weight % methacrylic acid, having a relatively high viscosity (melt index of 35 according to ASTM D-1238 (@190° C. with a weight of 2.16 Kg)). The adhesive resin was applied to the back of the primary backing as shown in FIG. 1 except that no secondary backing was used. The nip roll was a 6 inch (15.2 cm) diameter roll with a rubberized surfaced having an 80 shore A hardness which was covered with a 1.5 mm thick Teflon® sleeve. The chill roll 6 was a 750 cm diameter roll with a metal surface that was cooled to the temperature shown in Table 1. In Comparative Example 1, the adhesive was applied at a low level of 100 g/m² at an extrusion temperature of 230° C. In Comparative Example 2, the adhesive was applied at a level of 700 g/m² at an extrusion temperature of 230° C.

In Comparative Example 1, where the coating weight and extrusion temperature were both low for the low melt index polymer adhesive used, it can be seen that the results of both the Lisson Tretrad fiber retention test and the ASTM-D-1335 Tuft Bind test were unacceptable. In Comparative Example 2, where the coating weight was increased significantly, and the extrusion temperature was held at 230° C., the results of the Lisson Tretrad fiber retention test were still unacceptable whereas the carpet exhibited an acceptable tuft bind of 9.4 Newtons under the ASTM-D-1335 Tuft Bind test.

### Example 3

In Example 3, a 50 cm wide carpet was prepared using the nip roll and chill roll described in Comparative Examples 1 and 2. In addition, two 3 cm diameter diverting rolls were added just before the nip so as to direct the tufted primary backing into the nip at an angle that made it possible to reduce the distance that the molten polymer film had to travel between the exit of the adhesive die and the backside of the primary backing. This distance was set at 5 cm.

The carpet was a cross over cut pile carpet of 1/10 gauge with a face fiber weight of about 500 g/m². The primary backing was a 108 g/m² polypropylene spunbonded nonwoven and the face yarn was a 1000 dTex BCF nylon 66 yarn.

The primary polymer adhesive was a copolymer of ethylene with 19 weight % methacrylic acid, having a melt index of 395 according to ASTM D-1238 (@190° C. with a weight of 2.16 Kg). The polymer adhesive had an adhesion for nylon 6,6 of 4.1 N/10 mm and a tensile strength of 11.2 MPa.

The primary polymer adhesive was applied to the back of the primary backing and then passed through the nip without the application of a secondary backing. The polymer adhesive was extruded at a temperature of 217° C. through a 0.8 mm wide die opening at a basis weight of 250 g/cm². The pressure in the nip was 18.2 Kg.cm, the chill roll temperature was 12° C., and the line speed was 20 meters/min.

In a separate step, a secondary polymer adhesive was coated over the primary polymer adhesive and a secondary backing was adhered to the back of the primary backing via the secondary polymer adhesive. The secondary backing was a 5 mm thick needlefelt fleece with a basis weight of about 550 g/m² comprised of 80% fine polypropylene fibers (−2 dtex) and 20% polyethylene terephthalate fibers. The secondary polymer adhesive was a copolymer of ethylene with 25 weight % vinyl acetate, having a melt index of 3 according to ASTM D-1238 (@190° C. with a weight of 2.16 Kg). The secondary polymer adhesive was extruded at a temperature of 217° C. through a 0.8 mm wide die opening. The pressure in the nip was 18.2 Kg.cm, the chill roll temperature was 12° C., and the line speed was 20 meters/min.

The finished carpet was tested for fiber retention according to the Lisson Tretrad fiber retention test. The ITR was 3.38, meaning virtually no loss of the carpet fibers during the test. Upon completion of the Lisson Tretrad fiber retention test, the visual aspect of the finished carpet was rated, according to DIN EN 1963-part A, as category 4 (very good).

### Example 4

In Example 4, a carpet was prepared using the nip roll, diverting rolls, and chill roll described in Examples 3. The distance that the molten polymer film had to travel between the exit of the adhesive die and the backside of the primary backing was set at 5 cm.

The carpet was a cross over cut pile carpet of 1/10 gauge with a face fiber weight of about 500 g/m². The primary backing was a 108 g/m² polypropylene spunbonded nonwoven and the face yarn was a 1000 dTex BCF nylon 66 yarn.

The primary polymer adhesive was a copolymer of ethylene with 10 weight % methacrylic acid, having a melt index of 500 according to ASTM D-1238 (@190° C. with a weight of 2.16 Kg). The polymer adhesive had an adhesion for nylon 6,6 of 2.3 N/10 mm and a tensile strength of 6.8 MPa.

The primary polymer adhesive was applied to the back of the primary backing and then passed through the nip without the application of a secondary backing. The polymer adhesive was extruded at a temperature of 218° C. through a 0.8 mm wide die opening at a basis weight of 300 g/m². The pressure in the nip was 18.2 Kg.cm, the chill roll temperature was 12° C., and the line speed was 20 meters/min.

In a separate step, a secondary polymer adhesive was coated over the primary polymer adhesive and a secondary backing was adhered to the back of the primary backing via the secondary polymer adhesive. The secondary polymer adhesive was the same as the primary adhesive polymer. The secondary backing was a 5 mm thick needlefelt fleece with a basis weight of about 550 g/m² comprised of 80% fine polypropylene fibers (˜2 dtex) and 20% polyethylene terephthalate fibers. The secondary polymer adhesive was extruded at a temperature of 218° C. through a 0.8 mm wide die opening. The pressure in the nip was 18.2 Kg.cm, the chill roll temperature was 12° C., and the line speed was 20 meters/m in.

The finished carpet was tested for fiber retention according to the Lisson Tretrad fiber retention test. The ITR was 3.67, meaning there was virtually no fiber loss during the test. Upon completion of the Lisson Tretrad fiber retention test, the visual aspect of the finished carpet was rated, according to DIN EN 1963-part A, as category 3 (good).

TABLE 1

| | | 1 | 2 | | |
|---|---|---|---|---|---|
| | EXAMPLE | (Control) | (Control) | 3 | 4 |
| First step extrusion | Adhesive Basis Weight | 100 | 700 | 250 | 300 |
| coating | (g/m²) | | | | |
| | Extrusion Melt Temp. (° C.) | 230 | 230 | 217 | 218 |
| | Adhesive Melt Index | 35 | 35 | 395 | 500 |
| | Chill Roll Temperature (° C.) | 12 | 12 | 12 | 12 |
| | Line Speed (m/mm) | 25 | 8 | 20 | 20 |
| | Air Gap mm | 200 | 200 | 50 | 50 |
| | Nip Pressure (Kg.cm) | 27.3 | 27.3 | 18.2 | 18.2 |
| Second step | Adhesive Basis Weight | — | — | 250 | 300 |
| extrusion coating | (g/m²) | | | | |
| | Extrusion Melt Temp. (° C.) | — | — | 217 | 218 |
| | Chill Roll Temperature (° C.) | — | — | 12 | 12 |
| | Line Speed (m/min) | — | — | 20 | 20 |
| | Air gap cm | — | — | 50 | 50 |
| | Nip Pressure (Kg.cm) | — | — | 18.2 | 18.2 |
| PROPERTIES | Tuft Bind (Newtons) | <2 | 9.4 | — | — |
| | M_{RV}-Percent Fiber Loss | 88.7 | 58.4 | <1 | <1 |
| | (%) | | | | |
| | Visual aspect | 1 (failure) | 1 (failure) | 4 (very | 3 (good) |
| | | | | good) | |
| | I_{TR} | 0.48 | 1.77 | 3.38 | 3.67 |

### Example 5

In Example 5, a carpet was prepared using the flat bed laminator shown in FIG. 5. The carpet was a loop pile carpet with a face fiber weight of 690 g/m². The primary backing was a 108 g/m² polypropylene spunbonded nonwoven and the face yarn was a 1360 dTex BCF nylon 66 yarn.

The polymer adhesive was a terpolymer of ethylene with 10 weight % i-butyl acrylate, 10 weight % methacrylic acid, having a melt index of 400 according to ASTM D-1238 (@190° C. with a weight of 2.16 Kg). The polymer adhesive had an adhesion with nylon 6,6 of 11.6 N/10 mm and tensile strength of 6.0 MPa.

The tufted primary backing was deposited onto a moving belt with the face yarn side of the carpet facing down. The belt was traveling at 4 meters/min. The polymer adhesive was coated on the backside of the primary backing at a melt temperature of 230° C. and at a basis weight of about 2500 g/m², and was covered by a secondary backing. The secondary backing was a 5 mm thick needlefelt fleece with a basis weight of about 550 g/m² comprised of 100% fine (−2 dtex) polyethylene terephthalate fibers fibers. The carpet was next passed through a flat bed laminator like that described above with regard to FIG. 5. The carpet first passed between a set of two belts that applied a surface pressure of about 2.5 N/cm² to the carpet. The belts of the laminator were heated to between 130 and 150° C. by resistance heating modules having flat surfaces that pressed against the back of the belts. The gap between the belts was set at 7 mm. At the end of a 3 m long heated section, the belts, with the carpet between them, passed through a nip that was maintained with a constant opening of 6 mm. The pressure in the nip was 10 N/cm². The belts, with the carpet between them next continued into a cooling section where the belts passed between a series of spring-loaded water-chilled modules having a smooth non-sticking surface that pressed against the moving belts so as to maintain a gap of 7 mm between the belts. At the end of the 2 m long cooling section, the belts were removed from the carpet by two rollers. No additional chill rolls were used.

The finished carpet was tested for fiber retention according to the Lisson Tretrad fiber retention test procedure. Upon completion of the Lisson Tretrad fiber retention test procedure, the visual aspect of the finished carpet was rated as category 4 (very good) according to DIN 1963A.

### Example 6

In Example 6, a carpet was prepared using the flat bed laminator shown in FIG. 5. The carpet was a level loop pile carpet with a face fiber weight of 460 g/m². The primary backing was a 108 g/m² polypropylene spunbonded nonwoven and the face yarn was a 1360 dTex BCF nylon 66 yarn.

The polymer adhesive was a terpolymer of ethylene with 10 weight % i-butyl acrylate, 10 weight % methacrylic acid, having a melt index of 400 according to ASTM D-1238 (@190° C. with a weight of 2.16 Kg). The polymer adhesive had an adhesion with nylon 6,6 of 11.6 N/10 mm and tensile strength of 6.0 MPa.

The tufted primary backing was unrolled from a supply roll onto a moving belt with the face yarn side of the carpet facing down. The belt was traveling at 4 meters/min. The polymer adhesive was coated on the backside of the primary backing at a melt temperature of 150° C. at a basis weight of about 2500 g/m², and was covered by a secondary backing. The secondary backing was a 3.5 mm thick needlefelt fleece with a basis weight of about 350 g/m² comprised of 100% fine (˜2 dtex) polyethylene terephthalate fibers. The carpet was next passed through a flat bed laminator like that described above with regard to FIG. 5. The carpet first passed between a set of two belts that applied a surface pressure of about 2.5 N/cm² to the carpet. The belts of the laminator were heated to 130 to 150° C. by resistance heating modules having flat surfaces that pressed against the back of the belts. The gap between the belts was set at 7 mm. At the end of a 3 m long heated section, the belts, with the carpet between them, passed through a nip that was maintained with a constant opening of 6 mm. The resulting pressure in the nip was about 10 N/cm². The belts, with the carpet between them next continued into a cooling section where the belts passed between a series of spring-loaded water-chilled modules having a smooth non-sticking surface that pressed against the moving belts so as to maintain a gap of 7 mm between the belts. At the end of the 2 m long cooling section, the belts were removed from the carpet by two rollers. No additional chill roll was used.

The finished carpet was tested for fiber retention according to the Lisson Tretrad fiber retention test procedure. Upon completion of the Lisson Tretrad fiber retention test procedure, the visual aspect of the finished carpet was rated as category 4 (very good) according to DIN 1963A.

1. A tufted carpet comprising:
a primary backing with yarn comprised of at least 85% by weight of fibers selected from the group nylon fibers, wool fibers, and blends thereof, said tufted primary backing having a carpet side and an opposite back side,
a polymer adhesive applied to the back side of the tufted primary backing, said polymer adhesive contacting the primary backing and fibers of the yarn tufted in the primary backing, said polymer adhesive consisting of at least 85% by weight of one or more ethylene copolymers each comprised of 50 to 95 weight % of ethylene, and 5-50 weight % of at least one comonomer selected from the group of esters and carboxylic acids, said polymer adhesive having a melt index greater than 150 according to ASTM D-1238@190° C. with a weight of 2.16 Kg, and a tenacity at room temperature of at least 5 Mpa according to test method DIN 53504-85, and
a secondary backing adhered to the back side of the primary backing.

2. The carpet of claim 1 wherein the comonomer group of esters and carboxylic acids consists of vinyl acetate, butyl acrylate, methyl acrylate, methacrylic acid, and acrylic acid.

3. The carpet of claim 2 wherein the polymer adhesive is a terpolymer containing 50-90 weight % ethylene, 5-20 weight % butyl acrylate, and 5-20 weight % methacrylic acid.

4. The carpet of claim 2 wherein at least 20 weight % of the polymer adhesive is a copolymer containing 50-95 weight % ethylene and 5-50 weight % metharcylic acid.

5. The carpet of claim 4 wherein at least 20 weight % of the polymer adhesive is a copolymer containing 50-95 weight % ethylene and 5-50 weight % vinyl acetate.

6. The carpet of claim 2 wherein the polymer adhesive has a melt index in the range of 200 to 800 according to ASTM D-1238@190° C. with a weight of 2.16 Kg.

7. The carpet of claim 6 wherein the polymer adhesive has a melt index in the range of 400 to 600 according to ASTM D-1238@190° C. with a weight of 2.16 Kg.

8. The carpet of claim 1 wherein the polymer adhesive has an adhesion to polyamide 6,6 of at least 2 Newtons per 10 mm according to test method Nylon Adhesion Test Method.

9. The carpet of claim 6 wherein the polymer adhesive has an adhesion to polyamide 6,6 of at least 5 Newtons per 10 mm according to test method Nylon Adhesion Test Method.

10. The carpet of claim 2 wherein the secondary backing is adhered directly to the back of the primary backing by said polymer adhesive, and wherein the secondary backing comprises a textile fabric comprised of at least 85% by weight of fibers comprised of polymers selected from the group of polyolefins, polyesters and polyamides.

11. The carpet of claim 10 further comprising a reinforcing grid between the back side of the primary backing and the secondary backing, said reinforcing grid being adhered directly to the back of the primary backing and to the secondary backing by said polymer adhesive.

12. The carpet of claim 11 wherein the reinforcing grid is an open fiberglass mat.

13. The carpet of claim 1 wherein the primary backing is comprised of a spunbonded polyolefin nonwoven.

14. The carpet of claim 1, wherein the tufted carpet has a fiber retention index of at least 3, measured according to the Lisson Tretrad test.

15. A process for preparation of a tufted polyamide-type fiber carpet comprising
providing a primary backing tufted with yarn comprised of at least 85% by weight of fibers selected from the group nylon fibers, wool fibers, and blends thereof, said tufted primary backing having a carpet side and an opposite back side,
providing a molten polymer adhesive on the back side of the tufted primary backing, said polymer adhesive consisting of at least 85% by weight of one or more ethylene copolymers each comprised of 50 to 95 weight % of ethylene, and 5-50 weight % of at least one comonomer selected from the group of esters and carboxylic acids, said polymer adhesive having a melt index greater than 150 according to ASTM D-1238@190° C. with a weight of 2.16 Kg, and a tenacity of at least 5 Mpa according to test method DIN 53504-85,
introducing the tufted primary backing with the molten polymer adhesive into a nip and compressing molten polymer adhesive into said tufted primary backing in said nip, and
cooling said molten polymer adhesive to a temperature below the melting point of said molten adhesive.

16. The process of claim 15 wherein the polymer adhesive has an adhesion to polyamide 6,6 of at least 2 Newtons per 10 mm according to test method DIN 53504-85.

17. The process of claim 15 comprising the additional step of adhering a secondary backing to the back of the primary backing so as to form the tufted primary backing, the polymer adhesive and the secondary backing into an integral tufted carpet.

18. The process of claim 17 wherein the step of adhering the secondary backing to the back of the primary backing comprises
providing the secondary backing,
bringing the side of the secondary backing into contact with the back side of the tufted primary backing to which the molten polymer adhesive has been applied,
compressing said tufted primary backing, said molten polymer adhesive layer, and said secondary backing under a moving belt that applies a pressure of at least 1 N/cm² for a period of at least 10 seconds during which time the polymer adhesive remains in a molten state,
removing the moving belt from the tufted primary backing, molten polymer adhesive layer, and secondary backing, and then cooling said molten polymer adhesive to a temperature below the melting point of said molten adhesive so as to form the tufted primary backing the polymer adhesive and the secondary backing into an integral tufted carpet.

19. The process of claim 15 wherein the extrusion temperature of the molten polymer adhesive is in the range of 150 to 325° C.

20. The process of claim 15 further comprising the step of introducing a reinforcing grid between the back side of the tufted primary backing and the secondary backing prior to the step of compressing said tufted primary backing, said molten polymer adhesive layer, and said secondary backing in said nip.

21. The process of claim 16 wherein the comonomer selected from the group of esters and carboxylic acids consists of vinyl acetate, butyl acrylate, methyl acrylate, methacrylic acid, and acrylic acid.

22. The process of claim 16 wherein the polymer adhesive is a terpolymer containing 50-90 weight % ethylene, 5-20 weight % butyl acrylate, and 5-20 weight % methacrylic acid.

23. The process of claim 16 wherein at least 20 weight % of the polymer adhesive is a copolymer containing 50-95 weight % ethylene and 5-50 weight % metharcylic acid.

24. The process of claim 23 wherein at least 20 weight % of the polymer adhesive is a copolymer containing 50-95 weight % ethylene and 5-50 weight % vinyl acetate.

25. The process of claim 16 wherein the polymer adhesive has a melt index in the range of 200 to 800 according to ASTM D-1238@190° C. with a weight of 2.16 Kg.

26. The process of claim 25 wherein the polymer adhesive has a melt index in the range of 400 to 600 according to ASTM D-1238@190° C. with a weight of 2.16 Kg.
